(19) United States
(12) Patent Application Publication
(10) Pub. No.: US 2015/0345519 A1
(43) Pub. Date: Dec. 3, 2015

(54) Magnetohydrodynamic actuator

(71) Applicant: Jan Vetrovec, Larkspur, CO (US)

(72) Inventor: Jan Vetrovec, Larkspur, CO (US)

(21) Appl. No.: 14/120,507

(22) Filed: May 27, 2014

(51) Int. Cl. F15B 15/20; F15B 15/04; H02K 44/04

(52) U.S. Cl. CPC F15B 15/202; H02K 44/04; F15B 15/04; F15B 15/20; F15B 2015/208

(57) ABSTRACT

The present invention is for an apparatus and method for an actuator using an magnetohydrodynamic (MHD) pump to electrically generate a hydraulic pressure and a flow in a liquid metal, thereby causing the liquid metal to act on and extend an expansion member such as extend bellows, membrane, rolling diaphragm, or a piston in a cylinder. The resulting mechanical displacement of the expansion member may be beneficially used to exert a force, pressure, and/or to move elements of a machine. In particular, mechanical displacement (stroke) of the actuator may actuate elements of a humanoid robot, or artificial limb prosthetic, or flight control surfaces of an aircraft. The actuator may be arranged to operate bi-directionally by reversing the polarity of the electric current supplied to the MHD pump. Force exerted by the MHD actuator may be controlled by varying the electric current of the MHD pump drive current.

### CROSS-REFERENCE TO RELATED APPLICATIONS

This application claims priority from U.S. provisional patent application U.S. Ser. No. 61/855,824, filed on May 25, 2014 and entitled “MAGNETOHYDRODYNAMIC ACTUATOR,” the entire contents of which are hereby expressly incorporated by reference.

### FIELD OF THE INVENTION

This invention relates generally to actuators for production of force and/or stroke effects and more specifically to electrically operable actuators.

### BACKGROUND OF THE INVENTION

An actuator is a type of motor for moving or controlling a mechanism or system. It is operated by a source of energy, usually in the form of an electric current, hydraulic fluid pressure, or pneumatic pressure, and it converts that energy into some kind of motion. An actuator is the mechanism by which a control system acts upon an environment. The control system can be simple (a fixed mechanical or electronic system), software-based (e.g., a printer driver, robot control system), or a human, or other agent. Performance metrics for actuators include speed, acceleration, and force, linear response, as well as energy efficiency and considerations such as mass, volume, operating conditions, and durability, among others. Actuators are used in a very broad range of applications including consumer products, industrial machinery, agricultural machinery, aerospace systems, and weapons.

Certain new and emerging applications including humanoid robots and advanced artificial limb prosthetics require actuators with capabilities generally corresponding to human muscles. These requirements are not conveniently met by traditional actuator technologies such as pneumatic, hydraulic, and electromechanical actuators, which were introduced in the 19^{th} century. In particular, pneumatic, hydraulic, and electromechanical actuator need a significant infrastructure for their operation (e.g., motors, compressors, pumps, valves, and plumbing), which greatly complicate the application system. Despite recent improvements, the large size, weight, complexity, and limited energy efficiency of pneumatic, hydraulic, and electromechanical actuators may impede the performance of the entire application system.

New actuator technologies introduced in recent decades include piezoelectric, phase-change wax, electro- or magneto-striction-type, and shape memory alloy actuators. These new actuators typically have a limited stroke and often require complex control electronics. In particular, piezoelectric actuators excel at nano- and micro-positioning as well as high frequency and high force operation, but they have only limited “long stroke” capabilities. In particular, piezoelectric actuators may generate a stroke in the millimeter range (and beyond) by mechanically connecting multiple elements in series. However, this approach requires very high driving voltages and complex drive electronics. The “long-stroke” piezoelectric actuators are also known for high power dissipation and may require significant cooling. The stroke limitations, complex controls, and mediocre energy efficiency make the use of piezoelectric actuators in humanoid robots and artificial limbs less attractive. Because humanoid robots and artificial limbs typically operate from batteries, energy efficiency is an important factor. In particular, the possibility of electric energy recovery from reverse stroke of the actuator is highly desirable. A capability for direct operation from batteries or unconditioned power supplies is also very desirable.

In summary, prior art does not teach an actuator, which is simultaneously simple, compact, lightweight, reliable, and efficient, can operate from unconditioned power supplies, and allows for energy recovery from reverse stroke. It is against this background that the significant improvements and advancements of the present invention have taken place.

### SUMMARY OF THE INVENTION

The present invention is for an actuator using an MHD pump to electrically generate a hydraulic pressure and a flow in a liquid metal, thereby causing the liquid metal to act on and extend an expansion member such as bellows, membrane, rolling diaphragm (also known as rolling bladder), or a piston in a cylinder. The resulting mechanical displacement of the expansion member may be beneficially used to exert a force, pressure, and/or to move elements of a machine. In particular, mechanical displacement (stroke) of the actuator may actuate elements of a humanoid robot, or artificial limb prosthetic, or flight controls of an aircraft.

In one embodiment, the MHD actuator of the subject invention may comprise an MHD pump fluidly coupled by flow ducts to a pair of expansion members. The interior of the pump, the ducts, and of the expansion members is filled with liquid metal. Upon energizing the MHD pump with a direct electric current, liquid metal is pumped from a first expansion member into a second expansion member. As a results, the first expansion member contracts in volume and the second expansion member expands in volume. In particular, if the expansion members are linear expansion members (such as bellows, rolling diaphragm in a cylinder, or a piston in a cylinder), then the length of the first expansion member is reduced while the length of the second expansion member is increased. The MHD pump may be affixed to a structure and the second expansion member may be in a mechanical contact with a component of a machine. Therefore, energizing the MHD pump may cause force or pressure onto the component, or the component may be moved with respect to the structure. Upon reversing the polarity of the direct current energizing the MHD pump, liquid metal is pumped from the second expansion member into the first expansion member. As a results, the second expansion member contracts in volume and the first expansion member expands in volume.

In another embodiment, the MHD actuator of the subject invention may comprise an MHD pump fluidly coupled by flow duct to an expansion member and a reservoir. Upon energizing the MHD pump with a direct electric current, liquid metal may be pumped from the reservoir into the expansion member.

In yet another embodiment, the MHD actuator of the subject invention may comprise an MHD pump fluidly coupled by a flow duct to an expansion member configured as a diaphragm or a rolling diaphragm in a cylinder. The liquid metal acts on one side of the diaphragm. The other side of the diaphragm may be contacting a fluid enclosed in a vessel equipped with inlet and outlet valves. Repeated stroking of the diaphragm by the MHD pump may beneficially result in pumping of the fluid.

Magnetic field in the MHD pump may be generated by permanent magnets or by an electromagnet. The electromagnet may be electrically connected in series with the MHD pump electrodes. An MHD actuator equipped with an electromagnet (in lieu of permanent magnets) electrically connected in series with the MHD electrodes may be energized by alternating electric current.

The MHD actuator of the subject invention may beneficially offer a linear response. Force exerted by the MHD actuator of the subject invention may be varied by varying the electric current applied to the MHD pump. When using permanent magnets in the MHD pump and simultaneously exciting the pump with a low frequency AC current, the actuator may generate reciprocating stroking effect at the frequency of the AC current.

Unlike the recently introduced piezoelectric and striction-based actuators, the MHD actuator does not require electric power conditioning and it can be directly operated from a battery or other power sources. The MHD actuator also offers great robustness and reliability because it has no separable moving parts (only deflecting components).

The subject MHD actuator of the subject invention may be used to beneficially operate limbs of humanoid robots, artificial limb prosthetics, flight control surfaces of an aircraft, move wings of an ornithopter aircraft (aircraft with moving wings), operate reciprocating pumps, operate thrust vector control surfaces on a rocket, operate a canard on a projectile, or actuate components in an industrial equipment, aerospace vehicle, or an automotive vehicle.

The MHD pump used in the subject MHD actuator may be operated in reverse as an MHD generator, whereby flowing a liquid metal through the pump generates electric potential on the pump electrodes. Electric power generated in this matter may be harnessed. As a result, the MHD actuator may recover energy from a retraction stroke and recharge its electric power source.

These and other features and advantages of the invention will be more fully understood from the following description of certain specific embodiments of the invention taken together with the accompanying drawings.

Accordingly, it is an object of the present invention to provide a simple, compact, lightweight, size-scalable, and reliable actuator, which is also inexpensive to produce.

It is another object of the present invention to provide an actuator capable of energy recovery from a reverse actuator stroke.

It is yet another object of the present invention to provide an actuator for moving the limbs of a humanoid robot.

It is still another object of the present invention to provide an actuator for moving artificial limb prosthetics.

It is a further object of the present invention to provide an actuator for moving flight control surfaces in an aircraft, missile, or a projectile.

### BRIEF DESCRIPTION OF THE DRAWINGS

FIG. 1 is an isometric view of an MHD actuator in accordance with one preferred embodiment of the invention.

FIG. 2 is a cross-sectional view 2-2 of the MHD actuator of FIG. 1.

FIG. 3 is a cross-sectional view 3-3 of the MHD actuator of FIG. 1.

FIG. 4A is a cross-sectional view of an expansion member formed as a bellows.

FIG. 4B is a cross-sectional view of an expansion member formed as a diaphragm.

FIG. 4C is a cross-sectional view of an expansion member formed as a rolling diaphragm in a cylinder.

FIG. 4D is a cross-sectional view of an expansion member formed as a piston in a cylinder.

FIG. 5 is a cross-sectional view of the MHD actuator of FIG. 1 indicating a stroke in one direction.

FIG. 6 is a cross-sectional view of the MHD actuator of FIG. 1 indicating a stroke in opposite direction.

FIG. 7 is an isometric view of an MHD actuator in accordance with another embodiment of the subject invention exemplifying a self-contained and compact packaging.

FIG. 8 is a schematic diagram showing a double acting MHD actuator in accordance with yet another embodiment of the subject invention.

FIG. 9 is a schematic diagram showing an MHD actuator capable of unpowered position lock in accordance with still another embodiment of the subject invention.

FIG. 10 is a schematic diagram showing an embodiment of the MHD actuator operating a fluid pump in accordance with further embodiment of the subject invention.

FIG. 11 shows a cross-sectional view of an alternative MHD pump with four (4) pairs of electrodes.

FIG. 12 is a cross-sectional view 12-12 of the alternative MHD pump of FIG. 11 showing the electrodes electrically connected in-series.

### DETAILED DESCRIPTION OF THE PREFERRED EMBODIMENTS

Selected embodiments of the present invention will now be explained with reference to drawings. In the drawings, identical components are provided with identical reference symbols in one or more of the figures. It will be apparent to those skilled in the art from this disclosure that the following descriptions of the embodiments of the present invention are merely exemplary in nature and are in no way intended to limit the invention, its application, or uses.

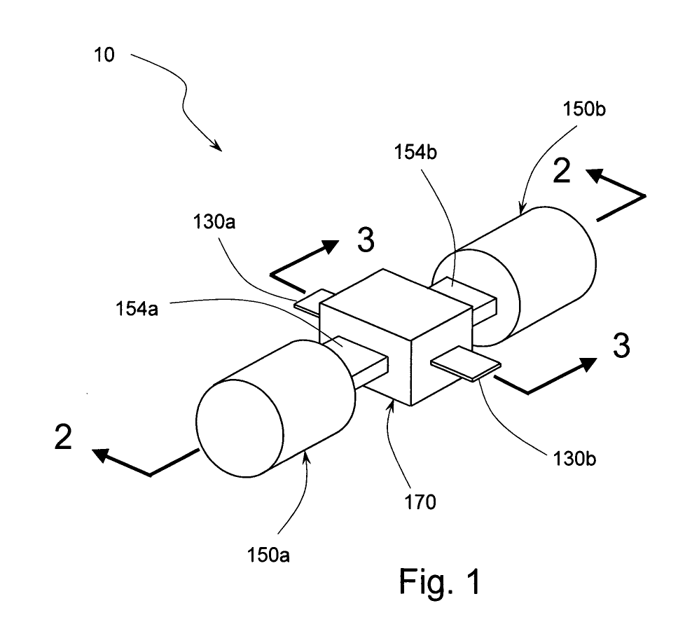

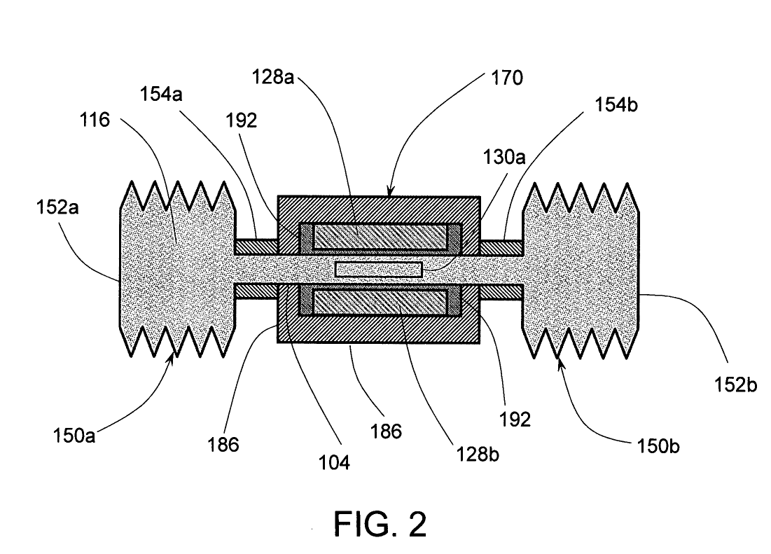

Referring now to FIGS. 1 and 2, there is shown an MHD actuator 100 in accordance with one preferred embodiment of the subject invention. The MHD actuator 100 comprises an MHD pump 170 fluidly connected by flow ducts 154a and 154b respectively to expansion members 150a and 150b. The internal volume of the MHD pump 170, the flow ducts 154a and 154b, and the expansion member 150a and 150b is filled with a suitable liquid metal 116.

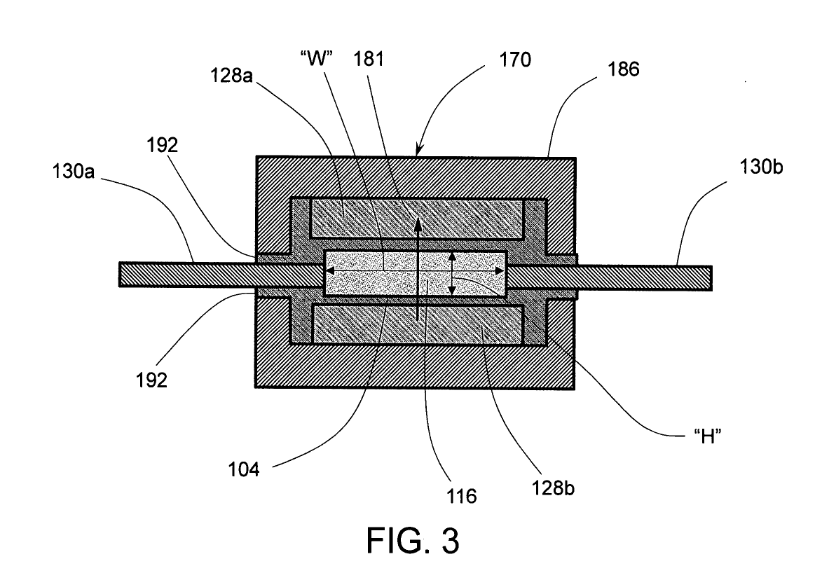

The MHD pump 170 is preferably formed in accordance with the U.S. patent application Ser. No. 13/999,257 entitled “Direct Current Magnetohydrodynamic Pump,” and filed by the Applicant on Feb. 3, 2014, which is hereby expressly incorporated by reference in its entirety. Referring now to FIGS. 2 and 3, in general, a suitable MHD pump 170 may comprise a core structure 186, permanent magnets 128a and 128b, electrodes 130a and 130b, and an electrical insulator 192. Internal to the MHD pump is a flow channel 104 filled with liquid metal 116. The flow channel 104 has a height “H” and width “W”, where W>>H. Preferably, H is in the range of about 0.1 to about 1 millimeter, whereas W is preferably in the range of about 3 to about 30 millimeters. Most preferably, the with W is at least five (5) times the height H.

The core structure 186 of the MHD pump is formed from a suitable ferromagnetic material capable of carrying magnetic flux at high density such as iron, steel, low carbon steel, core iron (e.g., Consumet® by Cartpenter Steel), pure iron, nickel-iron alloys such as Hiperco®, or alike. The electrical insulator 192 may be formed from epoxy, or plastic (e.g., Ultem), ceramic, or other are suitable dielectric material. The permanent magnets 128a and 128b are magnetized through their large faces in a direction parallel to the height H of the flow channel 104. For example, the magnetization vector of the permanent magnets 128a and 128b may be parallel to the arrow 181. The permanent magnets 128a and 128b are preferably a rare earth permanent magnets formed from samarium-cobalt (SmCo) or from neodymium-iron-boron (NdFeB) materials.

The electrodes 130a and 130b are preferably made of tungsten, tantalum, or other suitable material having high electrical conductivity as well as robustness to erosion by electrical arc. Alternatively, the electrodes may be made of copper or copper alloy and they may be plated with a suitable refractory metal such as, but not limited to molybdenum, tungsten, tantalum, ruthenium, osmium, and iridium.

The flow ducts flow ducts 154a and 154b may be pipes of arbitrary cross-section and length (preferably very short) fluidly and respectively connecting the MHD pump 170 to the expansion members 150a and 150b.

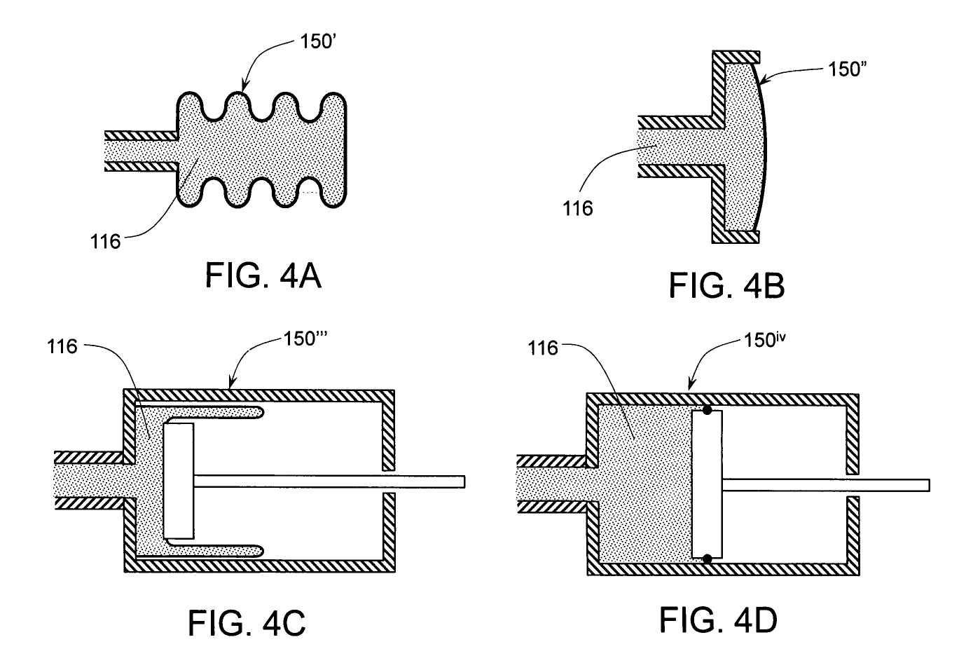

The expansion members 150a and 150b may be formed as bellows 150′ (FIG. 4A), diaphragm 150″ (FIG. 4B), rolling diaphragm in a cylinder 150′″ (FIG. 4C), or a piston in a cylinder 150^{iv} (FIG. 4D). Bellows may be formed from metal, plastic, elastomeric material, or rubber. Metal bellows may be electroformed or welded to attain a low spring constant. Diaphragm may be formed from elastomeric material, or rubber. Diaphragm may be smooth or convoluted.

Liquid metals are chemically stable and, unlike typical electrolytes, they beneficially do not decompose upon passage of electric current. Preferably, the liquid metal 116 has a good electrical conductivity, good thermal conductivity, low viscosity, and a low freezing point. For the purposes of this disclosure, the term “liquid metal” shall mean suitable metal (and its suitable alloys) that are in a liquid (molten) state at their operating temperature. Examples of suitable liquid metals include nontoxic room temperature melting alloys comprising of gallium, indium, and tin (GaInSn). Ordinary or eutectic liquid metal alloys may be used. Examples of suitable gallium-based liquid eutectic metal alloys include Indalloy 51 and Indalloy 60 (manufactured by Indium Corporation in Utica, N.Y.), galinstan (obtainable from Geratherm Medical AG in Geschwenda, Germany). In particular, galinstan is an eutectic alloy reported to contain 68.5% by weight of gallium, 21.5% by weight of indium and 10% by weight of tin, and having a melting point around minus 19 degrees Centigrade. Examples of suitable gallium-based liquid metal alloys may be also found in the U.S. Pat. No. 5,800,060 issued to G. Speckbrock et al., on Sep. 1, 1998. A new class of liquid metal alloys recently disclosed by Brandeburg et al. in the U.S. Pat. No. 7,726,972 and having reportedly extended useful temperature range down to minus 36 degrees Centigrade may be also usable with the subject invention. The Brandeburg's alloy differs from the commercially available GaInSn alloy in that it additionally includes 2%-10% of zinc (Zn). Mercury may be also used as a liquid metal in applications where toxicity is not of concern.

It is important that all surfaces of the MHD actuator 100 that may come into contact with the liquid metal be made of compatible materials. In particular, it is well known that liquid gallium and its alloys severely corrode many metals. Literature indicates that certain refractory metals such as tantalum, tungsten, and ruthenium may be stable in gallium and its alloys. See, for example, “Effects of Gallium on Materials at Elevated Temperatures,” by W. D. Wilkinson, Argonne National Laboratory Report ANL-5027, published by the U.S. Atomic Energy Commission (August 1953). To protect against corrosion, vulnerable surfaces that may come into contact with the liquid metal may be coated with suitable protective film. Suitable protective coatings and films for copper parts (e.g., the body 102) may include sulfamate (electroless) nickel, electroplated ruthenium, titanium nitride (TiN), and diamond-like coating (DLC). Diamond-like coating may be obtained from Richter Precision in East Petersburg, Pa. The Applicant has determined that core structure 186 made of substantially pure iron or core iron (e.g., Consumet® by Cartpenter Steel) may not require a protective coating. Reduced need for protective coatings simplifies fabrication and reduces cost.

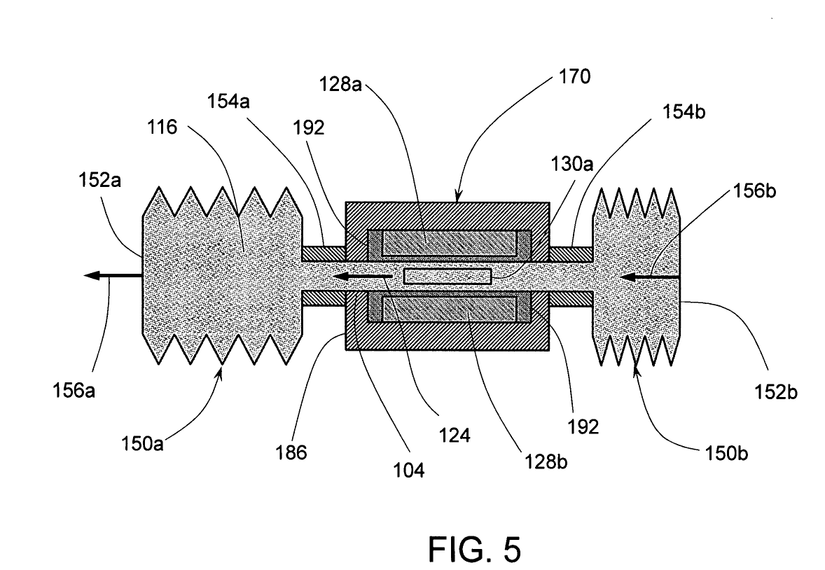

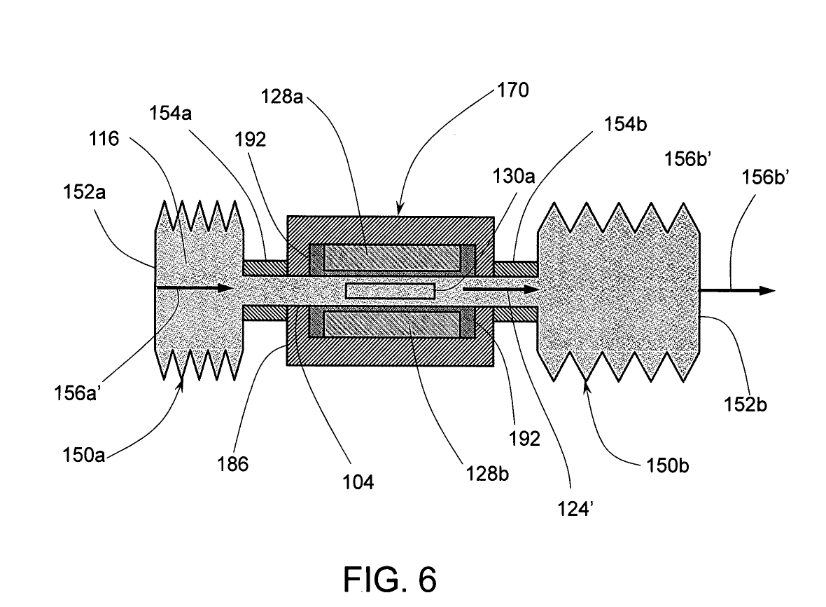

In operation, an electric potential is applied to the electrodes 130a and 130b of the MHD actuator 100 (FIG. 1). The liquid metal 116 inside the flow channel 104 makes an electrical contact with the electrodes 130a and 130b (as seen in FIG. 3) and allows electric current to flow through the liquid metal from one electrode to electrode. The direction of the electric current (as defined by the polarity of the electric current source) drawn though the liquid metal coolant is coordinated with the direction 181 of the magnetic field generated by the magnets 128a and 128b in the MHD pump 170, so that the resulting magneto-hydrodynamic (MHD) effect causes the liquid metal coolant 116 to flow inside the flow channel 104 in the direction indicated by the arrow 124 in FIG. 5. This pumping action of the MHD pump 170 increases the pressure inside the expansion member 150a and reduces the pressure inside the expansion member 150b. As a result, the expansion member 150a may expand and the expansion member 150b may contract. If the expansion member 150a is a linear expansion element such as bellows, rolling diaphragm, or piston in cylinder, the expansion element 150a may execute a stroke as indicated by the arrow 156a. Correspondingly, the expansion member 150b may execute a stroke as indicated by the arrow 156b. In particular, the surface 152a of the expansion member 150a may move away from the MHD pump 170. Similarly, the surface 152b of the expansion member 150b may move closer to the MHD pump 170. Either or both of the surfaces 152a and 152b may be mechanically connected to or contacted to an object or a component of a machine (not shown). As a result, the component may be subjected to a force, pressure, and/or be moved.

When the an electric potential applied to the electrodes 130a and 130b of the MHD actuator 100 is reversed, the resulting magneto-hydrodynamic (MHD) effect causes the liquid metal coolant 116 to flow inside the main flow channel portion 104 in the direction indicated by the arrow 124′ in FIG. 5. This pumping action of the MHD pump 170 builds up pressure in the expansion member 150b and reduces the pressure inside the expansion member 150a. As a result, the expansion member 150a may execute a stroke as indicated by the arrow 156a′. Correspondingly, the expansion member 150b may execute a stroke as indicated by the arrow 156b′. In particular, the surface 152a of the expansion member 150a may move closer to the MHD pump 170. Similarly, the surface 152b of the expansion member 150b may move further away from the MHD pump 170.

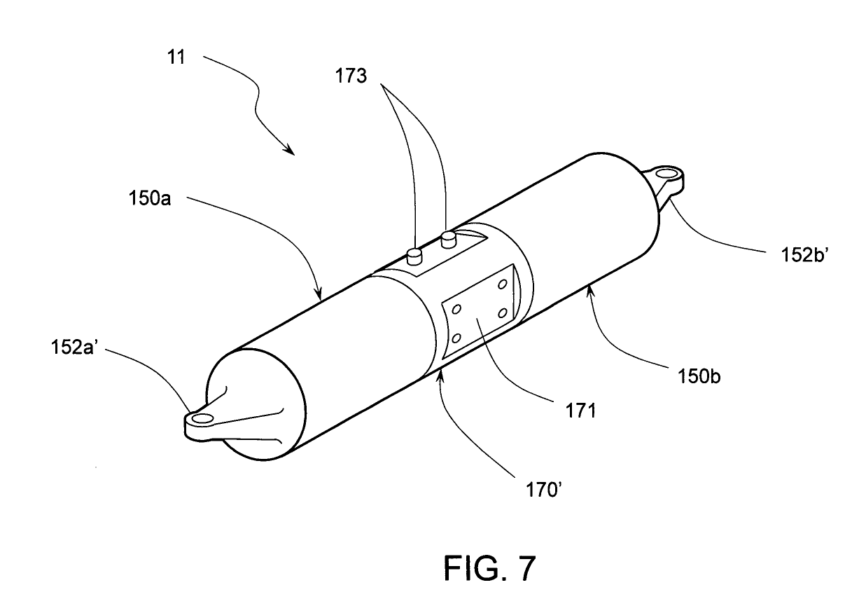

Referring now to FIG. 7, there is shown an isometric view of an MHD actuator 11 in accordance with another embodiment of the subject invention. The MHD actuator 11 is similar to the MHD actuator 10 of FIG. 1 and it shows a self-contained and compact packaging. The MHD pump 170′ has a surface 171, which can be used for attachment to a structure. Note that the surfaces 152a′ and 152b′ have been formed into connecting rod shape to allow for convenient mechanical coupling to machine components. Electric terminals 173 for the MHD pump 170 are conveniently installed on one side of the package.

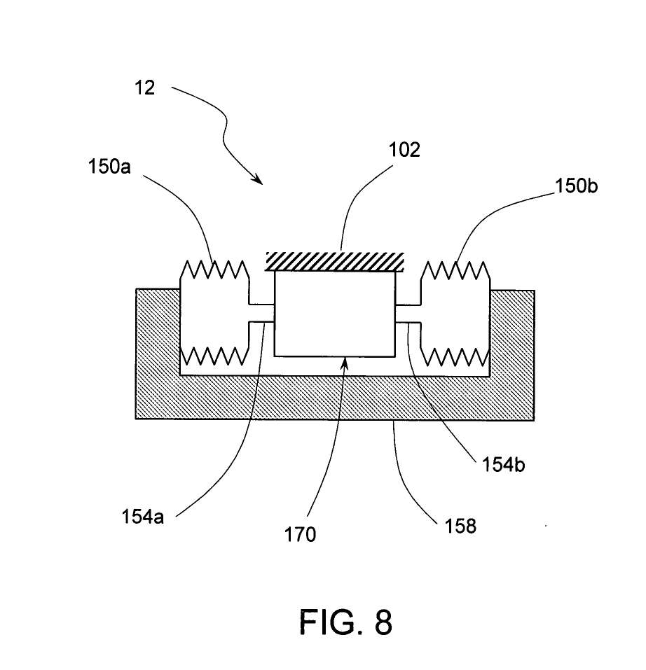

Referring now to FIG. 8, there is shown an MHD actuator 12 in accordance with yet another embodiment of the subject invention. The an MHD actuator 12 is similar to the MHD actuator 10 of FIG. 1 but it offers a double-acting feature. To achieve double acting, the two expansion elements 150a and 150b are mechanically linked by a rigid member 158. The MHD pump 170 may be attached to a structure 102.

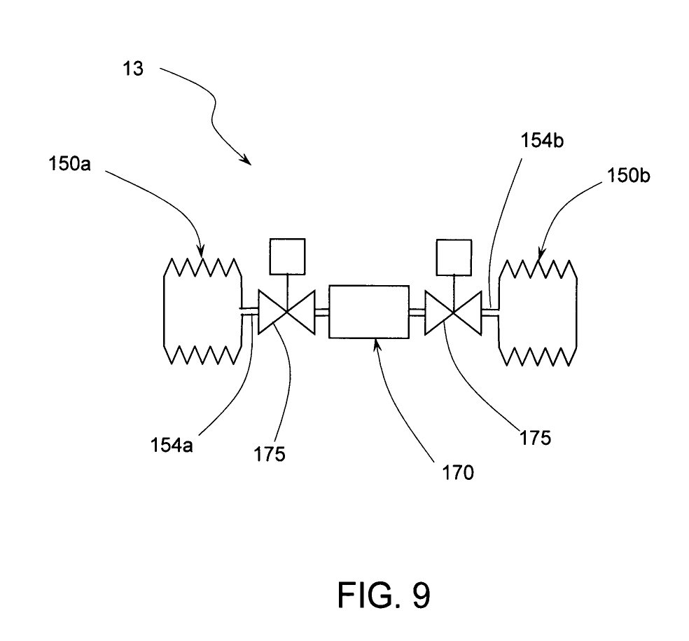

Referring now to FIG. 9, there is shown MHD actuator 13 in accordance with still another embodiment of the subject invention. The MHD actuator 13 is similar to the MHD actuator 10 of FIG. 1 but it is suitable for unpowered position locking. Position of the MHD actuator 13 may be locked by closing at least one of the control valves 175a and 175b respectively installed in the flow ducts 154a and 154b. With at least one of the control valves closed, the MHD actuator 13 may achieve substantial rigidity even when the MHD pump 170 is de-energized. In some variants of this embodiment, only one control valve may be used.

Another embodiment of the subject invention may be formed by a one of the expansion members is replaced by a liquid metal reservoir. Such a reservoir may be also formed as an elastomeric bladder.

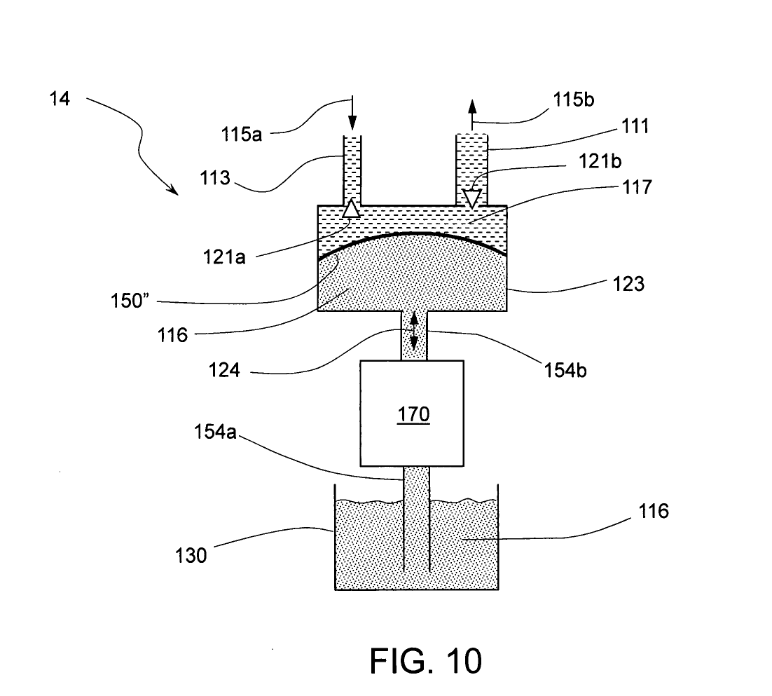

Referring now to FIG. 10, there is shown MHD actuator 14 in accordance with a further embodiment of the invention, which is particularly suitable for pumping fluids. The MHD actuator 14 comprises an MHD pump 170 fluidly coupled by a flow duct 154a to a liquid metal reservoir 130 and by a flow duct 154b to a vessel 123. The vessel 123 further comprises a diaphragm 150″, inlet ducts 113, outlet duct 111, and valve elements 121a and 121b. The valve elements may be automatically closing under pressure. The reservoir 130 contains liquid metal 116. The internal volumes of the MHD pump 170, flow ducts 154a and 154b, and the volume of the vessel 123 under the diaphragm 150″ are filled with liquid metal 116. The volume of the vessel 123 above the diaphragm 150″ and the inlet and outlet ducts are filled with a fluid 177, which may be a gas or a liquid.

In operation, the MHD pump is cyclically energized to flow liquid metal 116 into and out of the vessel 123. When the MHD pump 170 is energized to flow liquid metal 116 into the vessel 123, the diaphragm 150″ is extended and the fluid in the vessel 123 above the diaphragm is pressurized. The pressure causes the valve element 121a to close and the valve element 121b to open. As a result, the fluid 117 is expelled from the vessel 123 through the outlet duct 111 in the direction indicated by the arrow 115b. Conversely, when the MHD pump 170 is energized to flow liquid metal 116 out of the vessel 123, the diaphragm 150″ is retracted and the fluid in the vessel 123 above the diaphragm is de-pressurized. The de-pressurization causes the valve element 121a to open and the valve element 121b to close. As a result, fluid 117 is drawn through the inlet duct 113 into the vessel 123 in the direction indicated by the arrow 115a. Thus, by cycling the flow direction of the MHD pump 170, fluid 117 may be beneficially pumped.

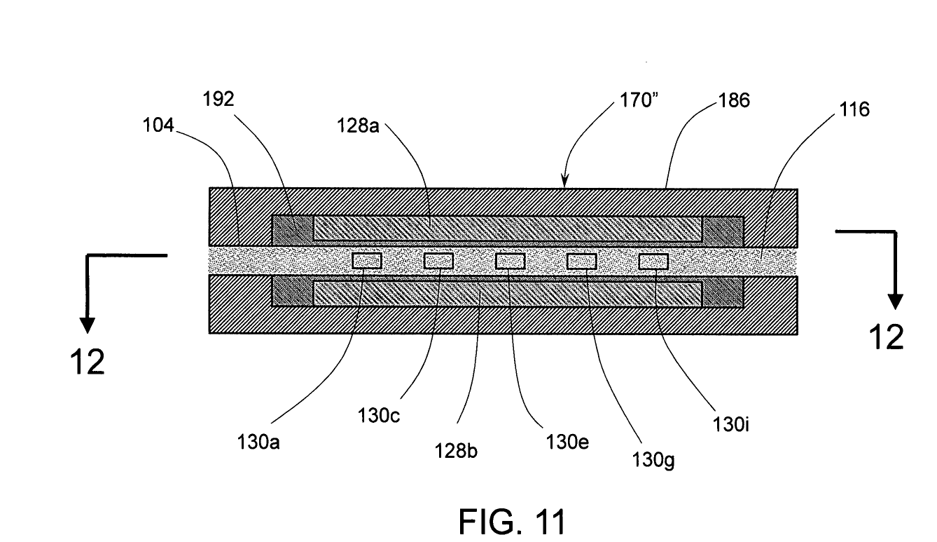

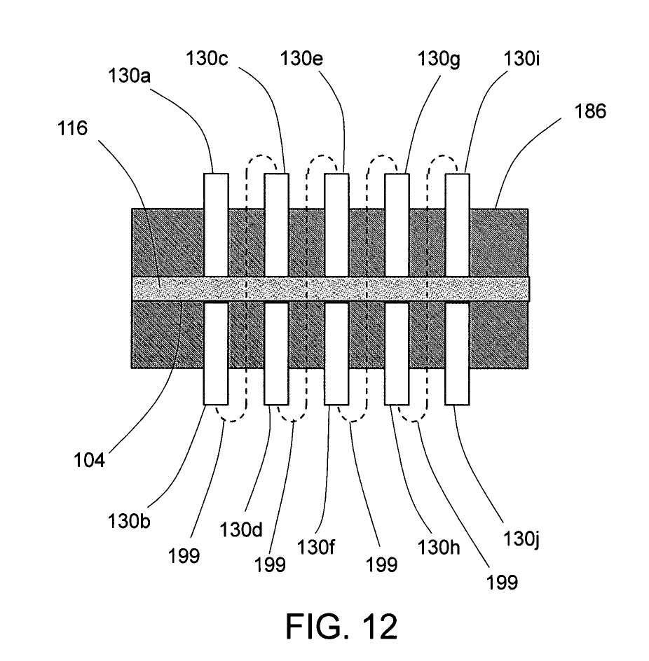

Output pressure of the MHD pump 170 can be increased by increasing the electric current applied to the electrodes. To attain very high pressures even at moderate electric current, the MHD pump may use multiple electrode pairs electrically connected in series. Referring now to FIGS. 11 and 12, there is shown an alternative MHD pump 170″ having five (5) electrode pairs facing the flow channel 104. Each of the electrode pairs 130a-130b, 130c-130d, 130e-130f, 130g-130h, and 130i-130j represents a pumping stage, which further increases the output pressure of the pump. The electrode pairs are connected in-series by electrical conductors 199. External electric potential may be applied to the electrodes 130a and 130j. The alternative MHD pump 170″ may be operated at a lower electric current and a higher voltage than the MHD pump 170 having only one electrode pair, which may be advantageous in some applications.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” and “includes” and/or “including” when used in this specification, specify the presence of stated features, integers, steps, operations, elements, and/or components, but do not preclude the presence or addition of one or more other features, integers, steps, operations, elements, components, and/or groups thereof.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

The term “suitable,” as used herein, means having characteristics that are sufficient to produce a desired result. Suitability for the intended purpose can be determined by one of ordinary skill in the art using only routine experimentation.

Moreover, terms that are expressed as “means-plus function” in the claims should include any structure that can be utilized to carry out the function of that part of the present invention. In addition, the term “configured” as used herein to describe a component, section or part of a device includes hardware and/or software that is constructed and/or programmed to carry out the desired function.

Different aspects of the invention may be combined in any suitable way.

While only selected embodiments have been chosen to illustrate the present invention, it will be apparent to those skilled in the art from this disclosure that various changes and modifications can be made herein without departing from the scope of the present invention as defined in the appended claims. Furthermore, the foregoing description of the embodiments according to the present invention are provided for illustration only, and not for the purpose of limiting the present invention as defined by the appended claims and their equivalents. Thus, the scope of the present invention is not limited to the disclosed embodiments.

What is claimed is:

1. A magnetohydrodynamic (MHD) actuator comprising a magnetohydrodynamic (MHD) pump, expansion member, flow duct, and liquid metal;
a) said MHD pump further comprising a permanent magnet, ferromagnetic core structure, and a pair of electrodes;
b) said flow duct fluidly coupling said MHD pump to said expansion member; and
c) said liquid metal substantially filling the internal volume of said MHD pump, said flow duct, and said expansion element.

2. The MHD actuator of claim 1, wherein said expansion member is selected from the group consisting of bellows, diaphragm, rolling diaphragm in a cylinder, and a piston in a cylinder.

3. The MHD actuator of claim 1, wherein said liquid metal is an alloy of gallium.

4. The MHD actuator of claim 1 further comprising a liquid metal reservoir; said reservoir being fluidly coupled to said MHD pump.

5. The MHD actuator of claim 4, wherein said reservoir is formed as a bladder.

6. The MHD actuator of claim 1 further comprising a control valve installed in said flow duct.

7. The MHD actuator of claim 6, wherein said control valve is arranged to close whenever said MHD pump is not energized by electric current.

8. The MHD actuator of claim 1 further comprising at least one additional pair of electrodes within said MHD pump; and all said pairs of electrodes being electrically connected in-series.

9. The MHD actuator of claim 1 further comprising a vessel including an inlet duct, outlet duct, and valve elements; said vessel being fluidly connected to said MHD pump via said flow duct; said expansion member being installed in said vessel; said valve elements arranged to pump a fluid when the flow direction of said liquid metal delivered by said MHD pump is repeatedly cycled.

10. A magnetohydrodynamic (MHD) actuator comprising a magnetohydrodynamic (MHD) pump, a first expansion member, a second expansion member, a first flow duct, a second flow duct, and liquid metal;
a) said MHD pump comprising a core structure, electric insulator, at least one permanent magnet, and at least one pair of electrodes;
b) said first flow duct fluidly connecting said MHD pump to said first expansion member;
c) said second flow duct fluidly connecting said MHD pump to said second expansion member; and
d) said liquid metal substantially filling the internal volume of said MHD pump, said first and second flow ducts, and said first and second expansion elements.

11. The MHD actuator of claim 10, wherein said first expansion member is selected from the group consisting of a bellows, diaphragm, rolling diaphragm, and a piston in a cylinder.

12. The MHD actuator of claim 10, wherein said second expansion member is selected from the group consisting of a bellows, diaphragm, rolling diaphragm, and a piston in a cylinder.

13. The MHD actuator of claim 10 further comprising a control valve installed in said first flow duct; and said control valve being arranged to close whenever said MHD pump is not energized by electric current.

14. The MHD actuator of claim 10 further comprising a rigid member arranged to mechanically link said first expansion member to said second expansion member.

15. A method for actuating a component comprising the steps of:
(a) providing a providing an MHD pump, a flow duct, and an expansion member; said MHD pump being fluidly coupled to said expansion element by said flow duct;
(b) providing a liquid metal which fills the internal volumes of said MHD pump, said flow duct, and said expansion element;
(c) supplying electric current to said MHD pump;
(d) causing said MHD pump to pump said liquid metal;
(e) pumping said liquid metal from said MHD pump through said flow duct to said expansion element;
(f) increasing the pressure of liquid metal in said expansion element;
(g) stretching said expansion element; and
(h) causing said expansion element to actuate a component.

16. The method for actuating a component of claim 15, wherein said step of supplying electric current to said MHD pump is intermittent.

17. The method for actuating a component of claim 15, wherein said step of supplying electric current includes periodic reversals of the current flow.

18. The method for actuating a component of claim 15, wherein said step of stretching said expansion element includes at least one of the group consisting of exerting pressure on an object, exerting force on an object, moving an object, pressurizing a fluid, and pumping a fluid.

19. The method for actuating a component of claim 15 further providing a valve installed in said flow duct; said valve being arranged to close whenever said MHD pump is not supplied with electric current.

20. The method for actuating a component of claim 15, wherein said expansion member is selected from the group consisting of a bellows, diaphragm, rolling diaphragm, and a piston in a cylinder.
